(19) United States
(12) Patent Application Publication
(10) Pub. No.: US 2026/0156068 A1
(43) Pub. Date: Jun. 4, 2026

(54) A Method for In-Network Aggregation Load Balancing

(71) Applicant: Huawei Technologies Co., Ltd., Shenzhen (CN)

(72) Inventor: Haoyu Song, San Jose, CA (US)

(21) Appl. No.: 19/460,099

(22) Filed: Jan. 26, 2026

Related U.S. Application Data
(63) Continuation of application No. PCT/US2023/028712, filed on Jul. 26, 2023.

(51) Int. Cl. H04L 45/24; H04L 47/125; H04L 47/34

(52) U.S. Cl. CPC H04L 45/24; H04L 47/125; H04L 47/34

(57) ABSTRACT

A system and method for performing load balancing in an In-Network Aggregation (INA) application is provided. A network server partitions data to be aggregated into data parts and sends the data parts in first packets to programmable network switches. Each programmable network switch receives a plurality of first packets, aggregates the first data parts to generate an aggregated data part, and sends the aggregated data part in a second packet to an aggregation network server. The aggregation network server receives a plurality of second packets and generates aggregated data from the aggregated data parts. Routing headers of the first packets may include the programmable network switch address as an intermediate waypoint and the aggregation network server address as a destination address. The routing headers may include a second programmable network switch address as a second intermediate waypoint. The data to be aggregated may be value vectors or key-value pairs.

### CROSS-REFERENCE TO RELATED APPLICATIONS

This application is a continuation of International Application No. PCT/US2023/028712, filed on Jul. 26, 2023, by Futurewei Technologies, Inc., and titled “A Method for In-Network Aggregation Load Balancing,” which is incorporated herein in its entirety.

### TECHNICAL FIELD

The present disclosure is generally related to in-network aggregation and specifically to in-network aggregation load balancing.

### BACKGROUND

In-Network Computing (INC) uses programmable network switches to execute an application function in part or in full, along with application servers in order to improve application performance and/or reduce system cost. In-Network Aggregation (INA) is an INC application and has two subtypes: (i) a synchronous all-reduce operation for distributed training in deep learning and (ii) an asynchronous key-value reduce operation for big data or High Performance Computing (HPC).

### SUMMARY

A first aspect relates to a method of load balancing in an In-Network Aggregation (INA) application, implemented in a programmable network switch, the method comprising receiving a plurality of first packets, each first packet comprising a first data part; aggregating the first data parts to generate an aggregated data part; and sending the aggregated data part in a second packet to an aggregation network server.

Optionally, in any of the preceding aspects, another implementation of the aspect provides each first data part comprises a value vector.

Optionally, in any of the preceding aspects, another implementation of the aspect provides each value vector is associated with a sequence number; a first set of value vectors are associated with a first sequence number and a second set of value vectors are associated with a second sequence number; generating an aggregated data part comprises aggregating the first set of data parts to generate a first aggregated data part and associating the first aggregated data part with the first sequence number; and aggregating the second set of data parts to generate a second aggregated data part and associating the second aggregated data part with the second sequence number; and sending the aggregated data part in a second packet to the aggregation network server comprises sending the first aggregated data part and the associated first sequence number; and the second aggregated data part and the associated second sequence number.

Optionally, in any of the preceding aspects, another implementation of the aspect provides each first data part comprises a set of key-value pairs.

Optionally, in any of the preceding aspects, another implementation of the aspect provides the first packets comprise routing headers, each routing header comprising (i) an intermediate waypoint comprising a network address of the programmable network switch and (ii) a destination address comprising a network address of the aggregation network server.

Optionally, in any of the preceding aspects, another implementation of the aspect provides the intermediate waypoint is a first intermediate waypoint; each routing header further comprises a second intermediate waypoint comprising a network address of a second programmable network switch; and each first data part comprises a first data subpart and a second data subpart, wherein the method further comprises, for each first packet: aggregating the first data subpart to generate a first aggregated data subpart; and sending the first aggregated data subpart and the second data subpart to the second programmable network switch in a third packet.

Optionally, in any of the preceding aspects, another implementation of the aspect further includes receiving a plurality of fourth packets, each fourth packet comprising a first aggregated data subpart and a second data subpart; aggregating the second data subpart to generate a second aggregated data subpart; and aggregating the first aggregated data subpart and the second aggregated data subpart to generate the aggregated data part.

Optionally, in any of the preceding aspects, another implementation of the aspect further includes receiving a plurality of fifth packets, each fifth packet comprising a first aggregated data subpart and a second data subpart; aggregating the second data subpart to generate a second aggregated data subpart; and sending the first aggregated data subpart and the second aggregated data subpart in a sixth packet to an aggregation network server.

Optionally, in any of the preceding aspects, another implementation of the aspect further includes determining, by the programmable network switch, that it cannot generate an aggregated data part and, in response, sending the first data parts to the aggregation network server.

A second aspect relates to a method of load balancing in an In-Network Aggregation (INA) application, implemented in a network server, the method comprising partitioning data to be aggregated into one or more data parts; and sending one or more first packets to corresponding programmable network switches, each first packet comprising one of the data parts.

Optionally, in any of the preceding aspects, another implementation of the aspect provides the data to be aggregated comprises one or more value vectors.

Optionally, in any of the preceding aspects, another implementation of the aspect provides each data part is associated with a sequence number, the method further comprising selecting a corresponding programmable network switch for the packet comprising the data part based on the sequence number associated with the data part.

Optionally, in any of the preceding aspects, another implementation of the aspect provides N programmable network switches are allocated for INA and selecting the corresponding programmable network switch is based further on a value of N.

Optionally, in any of the preceding aspects, another implementation of the aspect provides the data to be aggregated comprises one or more sets of key-value pairs.

Optionally, in any of the preceding aspects, another implementation of the aspect provides each key-value pair of the one or more sets of key-value pairs comprises a key index, the method further comprising partitioning the data to be aggregated into the one or more data parts based upon the key index value of each key-value pair.

Optionally, in any of the preceding aspects, another implementation of the aspect provides each set of the one or more sets of key-value pairs is associated with a job identifier, the method further comprising partitioning the data to be aggregated into the one or more data parts based upon the job identifier associated with each set of key-index pairs; and selecting a corresponding programmable network switch for the packet comprising the data part based on the job identifier associated with the data part.

Optionally, in any of the preceding aspects, another implementation of the aspect provides the first packets comprise routing headers, each routing header comprising (i) an intermediate waypoint comprising a network address of the corresponding programmable network switch and (ii) a destination address comprising a network address of an aggregation network server.

Optionally, in any of the preceding aspects, another implementation of the aspect provides the intermediate waypoint is a first intermediate waypoint and each routing header further comprises a second intermediate waypoint comprising a network address of a second programmable network switch.

Optionally, in any of the preceding aspects, another implementation of the aspect further includes partitioning each of the data parts into corresponding first and second data subparts, wherein sending the data parts to the corresponding programmable network switches comprises sending the corresponding first and second data subparts.

Optionally, in any of the preceding aspects, another implementation of the aspect provides the routing headers are one of an Internet Engineering Task Force (IETF) Segment Routing header and an IETF Service Function Chaining header.

A third aspect relates to a method of load balancing in an In-Network Aggregation (INA) application, implemented in a network server configured as an aggregation server, the method comprising receiving a plurality of first packets from a corresponding plurality of programmable network switches, each first packet comprising an aggregated data part; and generating aggregated data from the aggregated data parts.

Optionally, in any of the preceding aspects, another implementation of the aspect provides each aggregated data part comprises a value vector; and generating the aggregated data comprises aggregating the aggregated data parts into an aggregated value vector.

Optionally, in any of the preceding aspects, another implementation of the aspect provides each aggregated data part comprises a sub-vector of a value vector; and generating the aggregated data comprises concatenating the aggregated data parts into an aggregated value vector.

Optionally, in any of the preceding aspects, another implementation of the aspect provides each aggregated data part comprises a value vector and associated sequence number; and generating the aggregated data comprises assembling the aggregated data parts into a group of value vectors with associated sequence numbers.

Optionally, in any of the preceding aspects, another implementation of the aspect provides each aggregated data part comprises a set of key-value pairs; and generating the aggregated data comprises assembling the aggregated data parts into an aggregated set of key-value pairs.

Optionally, in any of the preceding aspects, another implementation of the aspect provides each aggregated data part comprises a set of key-value pairs associated with a job number; and generating the aggregated data comprises assembling the aggregated data parts into an aggregated set of sets of key-value pairs, each set of key-value pairs associated with a job number.

Optionally, in any of the preceding aspects, another implementation of the aspect provides the network server is configured as a parameter server.

Optionally, in any of the preceding aspects, another implementation of the aspect further includes sending the aggregated data to one or more other network servers.

Optionally, in any of the preceding aspects, another implementation of the aspect provides the network server is configured as an application server.

A fourth aspect relates to a system for performing load balancing in an In-Network Aggregation (INA) application. The system includes one or more network servers, one or more programmable network switches, and an aggregation network server, wherein a first network server of the one or more network servers is configured to partition data to be aggregated into one or more data parts; and sending one or more first packets to corresponding programmable network switches, each first packet comprising one of the data parts; the one or more programmable network switches are configured to receive a plurality of first packets, each first packet comprising a first data part; aggregating the first data parts to generate an aggregated data part; and send the aggregated data part in a second packet to an aggregation network server; and the aggregation network server is configured to receive a plurality of second packets from a corresponding plurality of programmable network switches, each second packet comprising an aggregated data part; and generate aggregated data from the aggregated data parts.

Optionally, in any of the preceding aspects, another implementation of the aspect provides the system is further configured to perform the method of any of the first, second, and third aspects.

A fifth aspect relates to a network apparatus, comprising a memory configured to store computer executable instructions; and a processor coupled to the memory and configured to execute the computer executable instructions to perform the method of any of the first, second, and third aspects.

Optionally, in any of the preceding aspects, another implementation of the aspect provides the memory comprises two or more memory components and the processor comprises two or more processor components.

A sixth aspect relates to a non-transitory computer readable storage medium comprising a computer program product for use by a network apparatus, the computer program product comprising computer executable instructions stored on the non-transitory computer readable storage medium that, when executed by one or more processors, cause the network apparatus to execute the method of any of the first, second, and third aspects.

A seventh aspect relates to a network apparatus, comprising a processing means for partitioning data to be aggregated into one or more data parts; and selecting one or more programmable network switches; and a transmitting means for transmitting the one or more data parts to the selected one or more programmable network switches.

Optionally, in any of the preceding aspects, another implementation of the aspect provides the system is further configured to perform the method of any of the first, second, and third aspects.

An eighth aspect relates to a network apparatus, comprising a receiving means for receiving one or more data parts; a processing means for generating one or more aggregated data parts from the one or more data parts; and a transmitting means for transmitting the one or more aggregated data parts to an aggregation network server.

Optionally, in any of the preceding aspects, another implementation of the aspect provides the system is further configured to perform the method of any of the first, second, and third aspects.

A ninth aspect relates to a network apparatus, comprising a receiving means for receiving one or more aggregated data parts; a processing means for generating aggregated data from the one or more aggregated data parts; and a transmitting means for transmitting the aggregated data to one or more network servers.

Optionally, in any of the preceding aspects, another implementation of the aspect provides the system is further configured to perform the method of any of the first, second, and third aspects.

For the purpose of clarity, any one of the foregoing embodiments may be combined with any one or more of the other foregoing embodiments to create a new embodiment within the scope of the present disclosure.

These and other features, and the advantages thereof, will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of a data center network.

FIGS. 2A-2C are data flow diagrams of synchronous all-reduce operations according to embodiments of the disclosure.

FIGS. 3A-3B are data flow diagrams of asynchronous key-value reduce operations according to embodiments of the disclosure.

FIGS. 4A-4B illustrate methods for load balancing in an INA application according to embodiments of the disclosure.

FIG. 5 is a diagram of a network apparatus according to an embodiment of the disclosure.

FIG. 6 is a diagram of an apparatus configured to implement one or more of the methods described herein according to embodiments of the disclosure.

### DETAILED DESCRIPTION

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In some distributed training applications (e.g., training of neural networks, or machine learning), each of M workers (or servers) in a data center network generates a gradient tensor vector (i.e., an array of values) substantially simultaneously. Gradient tensor vectors may also be referred to as value vectors. Such vectors from the M workers are sent in packets through the network to a Parameter Server (PS), in which a synchronous all-reduce operation is executed to calculate a tensor vector with an average gradient (e.g., by adding all the values at each index of the vector and dividing the sum by M). The PS then sends the resulting tensor vector through the network back to the workers for a next round of computing. Using INC, steps of the aggregation (e.g., adding all the values at each index for one or more of the M tensor vectors) can be performed in a programmable switch of the network on a forwarding path of the packets which receives all the tensor vectors. However, in some cases, due to limited resources, the programmable switch may not be able to perform aggregation of all the tensor vectors. In such cases, the remaining un-aggregated packets are forwarded to the PS for aggregation.

In other applications, workers in a data center network may work on multiple jobs (or tasks) of an application. In one example, an application may catalog individual words in a document and count the number of occurrences of each word. Each job in the application may process a single chapter or section of the document, for example. An individual worker may perform some or all of the work on one or more such jobs.

In each such job, the worker generates and sends a set of {key, value} pairs to a server for an asynchronous key-value reduce operation, in which all values for each key are aggregated. When the job is done, the results are retrieved as a final set of {key, value} pairs. In some cases, several network servers are used to perform the key-value reduce operation. Using INC, some of the aggregation work is performed in a programmable switch in the network which receives packets carrying the {key, value} pairs. However, in some cases, due to limited resources, the switch may be able to aggregate only a subset of the {key, value} pairs. In such cases, the remaining un-aggregated {key, value} pairs are forwarded to an application server for full aggregation.

Some INA solutions use a single programmable switch to perform aggregation. Where more than one programmable switch is used for aggregation, the configuration of such switches may be static and some constraints applied. To enable successful aggregation, the programmable switches are configured to receive all the data for aggregation—e.g., they may be top-of-rack switches. When aggregation is distributed to a plurality of programmable switches, complex signaling may be needed to determine in which programmable switch(es) the aggregation operation is being performed.

Under these constraints, the resources in a data center network that can be used for INA are restricted, with the result that existing solutions don't scale well. Methods according to embodiments of the disclosure solve this technical problem by enabling more of the programmable switches in a data center network to be used in aggregation operations, thereby utilizing more resources of the network to boost application performance.

In various embodiments of the disclosure, the number of programmable switches allocated aggregation operation may be easily increased or decreased, with different numbers of programmable switches allocated to a job based on, for example, its size or complexity. One job may be assigned more or fewer switches than another job. Jobs that are being executed at the same time may be assigned different sets of programmable switches that may overlap or be disjoint. When programmable switches are added to or removed from the network according to the embodiment, the number and identities of switches assigned to various jobs may be easily changed to adapt to the changes in the network configuration.

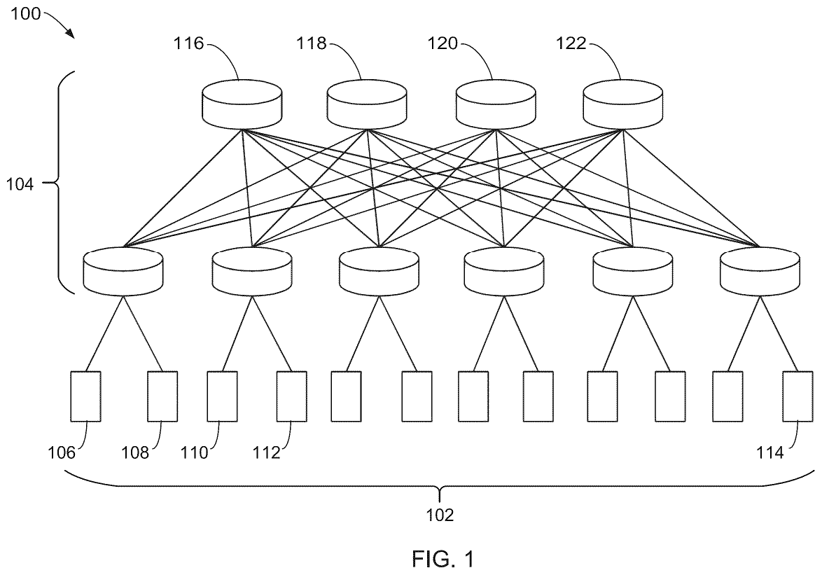

FIG. 1 is a diagram of a in a data center network 100. As shown, the data center network 100 includes network servers 102 and programmable switches 104. While twelve network servers and ten programmable switches are shown in the data center network 100, more or fewer network servers and/or programmable switches may be included in practical applications.

In the data center network 100, network servers 106, 108, 110, and 112 are configured respectively as workers and may be referred to herein as Workers 1, 2, 3, and 4, respectively. Network server 114 is configured as a parameter server in some embodiments herein and as an application server in other embodiments. Programmable switches 116, 118, 120, and 122 are configured as load-balancing switches (LBSs) and may be referred to herein as LBSs 1, 2, 3, and 4, respectively.

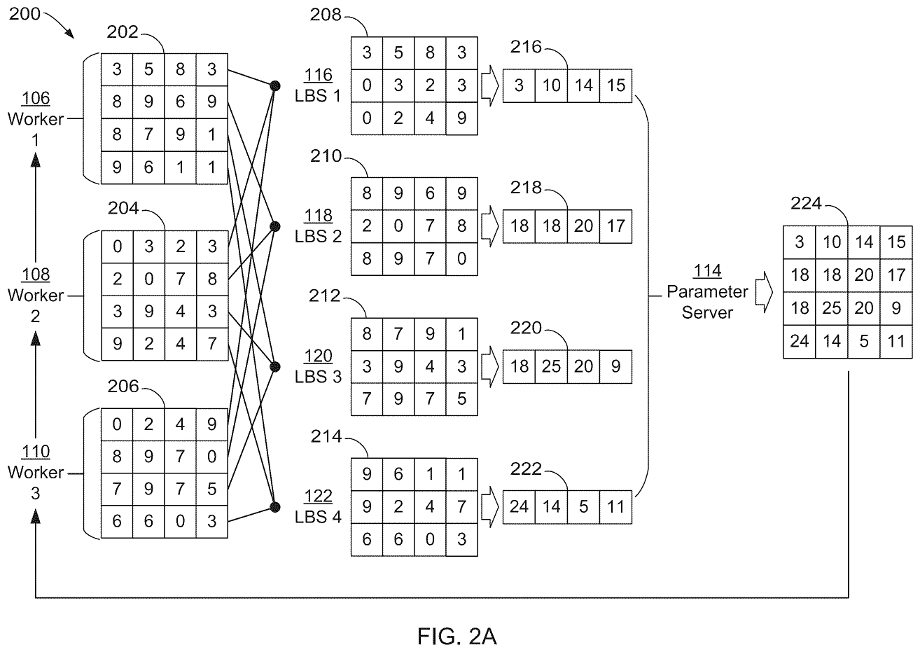

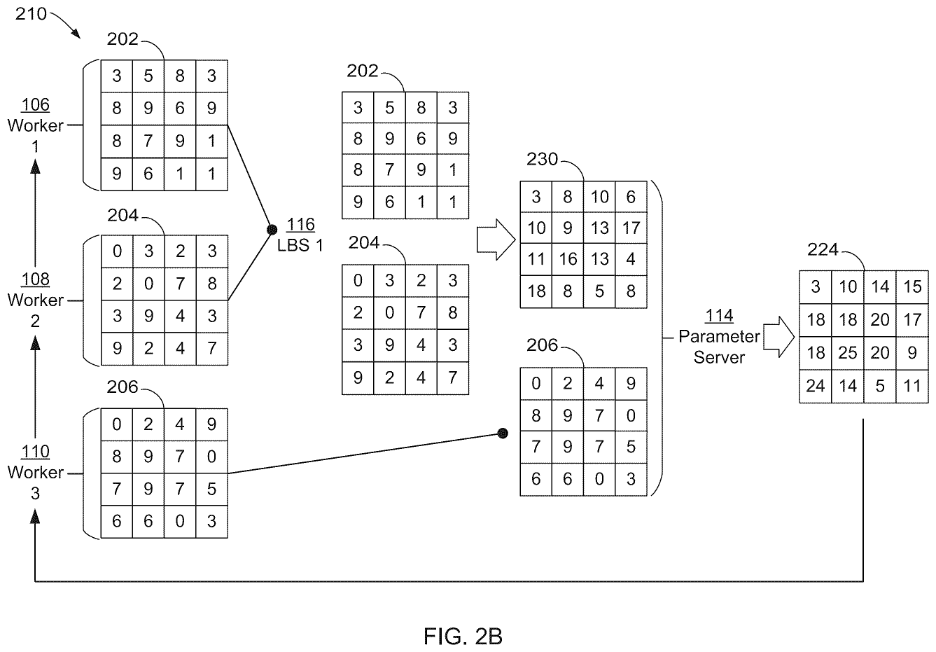

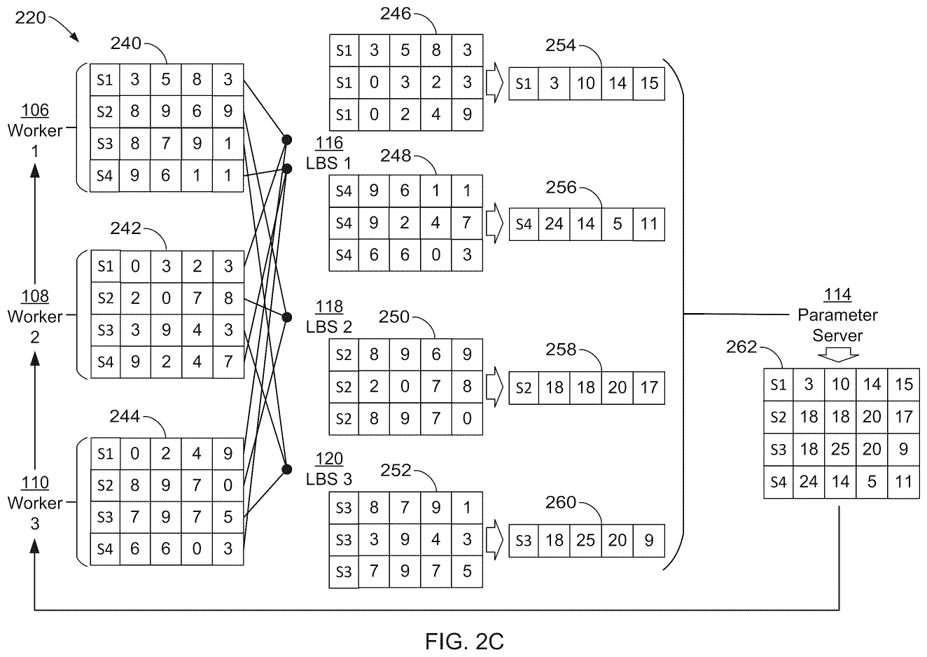

FIGS. 2A-2C are data flow diagrams of synchronous all-reduce operations according to embodiments of the disclosure. FIG. 2A illustrates a data flow 200 in which workers partition a value vector into N sections (i.e., N disjoint sub-vectors which can be concatenated to form the original vector) where N equals a number of LBSs allocated for INA. Each section is sent to one of the N LBSs for aggregation.

Where an LBS is unable to perform the aggregation operation (e.g., due to memory or time constraint), it sends its section to the PS for aggregation. The PS aggregates any unaggregated vector sections before concatenating the aggregated vector sections to form the aggregated value vector.

In FIG. 2A, the network servers 106, 108, and 110 (referred to here as workers 1, 2, and 3) produce respective 1×16 value vectors 202, 204, and 206 (depicted here as 4×4 blocks). Each of the workers 1, 2, and 3 partitions its value vector into four 1×4 vector sections and sends the sections to corresponding programmable switches. Each worker sends its first vector section to the programmable switch 116, its second vector section to the programmable switch 118, its third vector section to the programmable switch 120, and its fourth vector section to the programmable switch 122. The programmable switches 116, 118, 120, and 122 are referred to herein as LBS1, LBS2, LBS3, and LBS4, respectively.

LBS1, LBS2, LBS3, and LBS4 receive respective groups 208, 210, 212, and 214 of three vector sections each. Each of the LBSs performs an all-reduce aggregation operation on its group of vector sections to generate respective aggregated vector sections 216, 218, 220, and 222. Each of the LBSs sends its aggregated vector section to network server 114 (configured in this embodiment as a parameter server), which concatenates in order the aggregated vector sections to generate an aggregated value vector 224 (or aggregated data). The network server 114 may then send the aggregated value vector 224 to the workers 1, 2, and 3 for production of subsequent value vectors. In this embodiment, the value vectors 202, 204, and 206, the vector sections, the aggregated vector sections 216, 218, 220, and 222, and the aggregated value vector 224 may be referred to respectively as data to be aggregated, data parts, aggregated data parts, and aggregated data.

In the embodiment shown in FIG. 2A, the value vectors 202, 204, and 206 are partitioned into four sections, which are sent to four programmable switches 116, 118, 120, and 122. In other embodiments, the value vectors 202, 204, and 206 may be partitioned into more or fewer than four sections and may be sent to more or fewer than four programmable switches. For example, in an embodiment where only three programmable switches are allocated to INA, one of the three programmable switches may receive more than one section to aggregate. In this way, the corresponding programmable network switch is based on the number of programmable network switches in the network that are allocated to INA.

FIG. 2B illustrates a data flow 210 in which workers are grouped into N groups. The workers of each group send their full value vectors to a corresponding LBS at which the value vectors of the group are aggregated. Each LBS generates a partial aggregated value vector, which is sent to the PS for aggregation.

As described above, where an LBS is unable to perform the aggregation operation (e.g., due to memory or time constraint), it sends its section to the PS for aggregation. The PS aggregates any unaggregated vector sections before concatenating the aggregated vector sections to form the aggregated value vector.

In FIG. 2B, the network servers 106, 108, and 110 (referred to here as workers 1, 2, and 3) produce respective 1×16 value vectors 202, 204, and 206 (illustrated here in 4×4 blocks). The workers 1, 2, and 3 are grouped into two groups: a first group that includes workers 1 and 2, and a second group that includes only worker 3. The first group is assigned to LBS1. Because the second group includes only one worker, its value vector 206 does not undergo intermediate aggregation and is sent directly to the network server 114 (configured in this embodiment as a parameter server). Workers 1 and 2 send their respective value vectors 202 and 204 to the programmable switch 116 (referred to herein as LBS1). LBS1 aggregates value vectors 202 and 204 to generate a partial aggregated value vector 230, which is sent to the network server 114.

When the network server 114 has received both the value vector 206 and the partial aggregated value vector 230, the network server 114 aggregates the vectors to generate aggregated value vector 224 (or aggregated data). The network server 114 may then send the aggregated value vector 224 to the workers 1, 2, and 3 for production of subsequent value vectors. In this embodiment, the value vectors 202, 204, and 206, the partial aggregated value vector 230, and the aggregated value vector 224 may be referred to respectively as data to be aggregated, aggregated data parts, and aggregated data. The workers 1, 2, and 3 may be said to have partitioned their value vectors 202, 204, and 206 into single data parts, each of which includes all of its respective value vector.

FIG. 2C illustrates a data flow 220 in which workers produce a plurality of value vectors, each vector having an associated sequence number. The workers of each group send each of its value vectors individually to a selected LBS for aggregation. The identity of the selected LBS is based on the sequence number of the value vector. In some embodiments, the function Hash(S)% N is used to determine the identity, where Hash is a hashing function used by all workers, S is a vector's sequence number, % is the modulo operation, and N is a number of LBSs allocated to INA. Each LBS generates a complete aggregated value vector for one or more sequence numbers. The LBSs send their aggregated value vector(s) to the PS for full aggregation.

In FIG. 2C, the network servers 106, 108, and 110 (referred to here as workers 1, 2, and 3) each produces a group 240, 242, and 244 of four value vectors. Each value vector is associated with a sequence number S1, S2, S3, or S4. Programmable switches 116, 118, and 120 are allocated for INA and are referred to herein as LBS1, LBS2, and LBS3, respectively. As a result of the modulo operation discussed above, sequences S1, S2, S3, and S4 are sent respectively to LBS1, LBS2, LBS3, and LBS1.

LBS1 receives groups 246 and 248, each of three value vectors, associated respectively with sequences S1 and S4. LBS2 receives a group 250 of three value vectors associated with sequence S2. LBS3 receives a group 252 of three value vectors associated with sequence S3. LBS1 generates aggregated value vectors 254 and 256 from the groups 246 and 248, respectively. LBS2 generates aggregated value vector 258 from the group 250, and LBS3 generates aggregated value vector 260 from the group 252.

LBS1, LBS2, and LBS3 send their aggregated value vectors to network server 114 (configured in this embodiment as a parameter server), which assembles the aggregated value vectors into a group 262 of aggregated value vectors, each associated with a sequence number. The aggregated value vectors of the group 262 are arranged in sequence number order, but the network server 114 may arrange them in any other order in other embodiments. The network server 114 may then send the group 262 of aggregated value vectors (or aggregated data) to the workers 1, 2, and 3 for production of subsequent value vectors, each associated with a sequence number. In this embodiment, the groups of value vectors 240, 242, and 244, the aggregated value vectors 254, 256, 258, and 260, and the group 262 of aggregated value vectors may be referred to respectively as data to be aggregated, data parts, aggregated data parts, and aggregated data. The workers 1, 2, and 3 may be said to have partitioned their groups of value vectors 240, 242, and 244 into data parts comprising the value vector for a single sequence number.

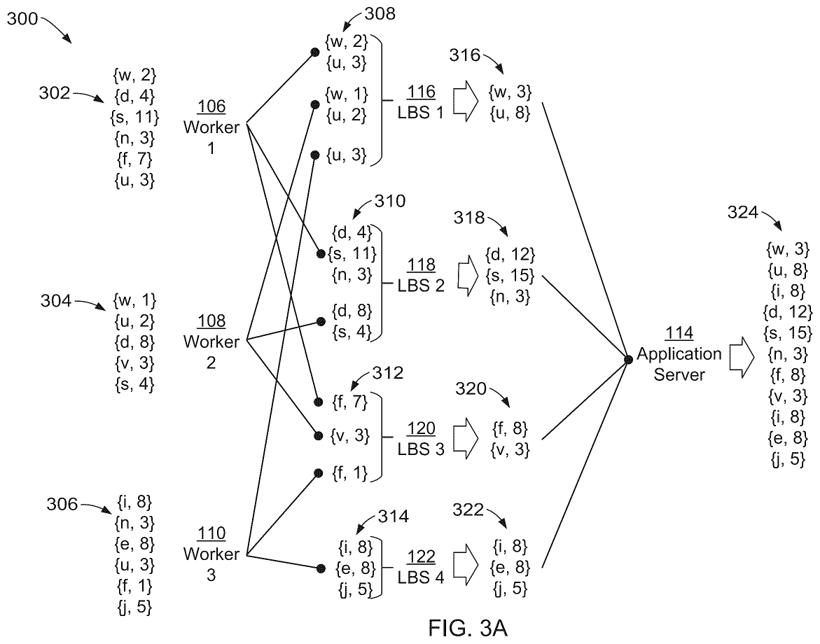

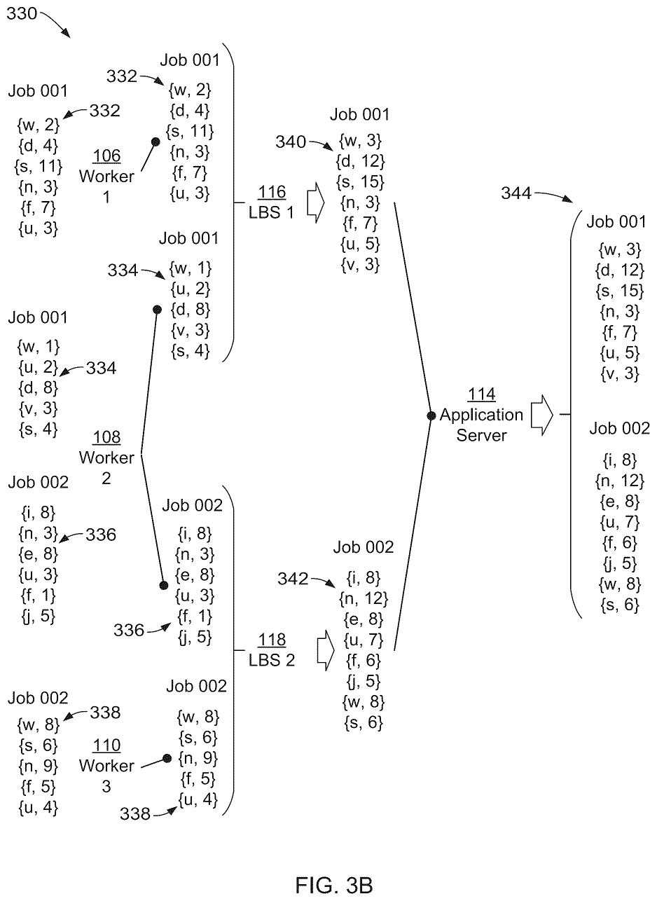

FIGS. 3A-3B are data flow diagrams of asynchronous key-value reduce operations according to embodiments of the disclosure. FIG. 3A illustrates a data flow 300 in which workers partition a set of key-value pairs (data to be aggregated) into data parts (or partitions). The data parts are N disjoint subsets of the set of key-value pairs, where N equals a number of LBSs allocated for INA. Each data part is sent to one of the N LBSs for aggregation. The aggregated data parts are sent to an application server for its use.

In some embodiments, each key-value pair includes a key index and the workers partition their key-value pairs based on the key index value of each pair. All workers may use the same function to partition their key-value pairs, so that all workers'first partitions include key-value pairs with the same subset of key index values, their second partitions include key-value pairs with the same subset of key index values, etc. Such a function may be the function Hash(k)% N, where Hash is a hashing function used by all workers, k is the key index value of a key-value pair, % is the modulo operation, and N is the number of LBSs allocated to INA.

The workers then send their first partitions to a first of the N LBSs, their second partitions to a second of the N LBSs, etc. In this way each LBS receives partitions comprising key-value pairs with a single subset of key index values, and the subset of key index values for partitions received by any one LBS is different from the subset of key index values for partitions received by another of the LBSs. Each LBS generates an aggregated partition (or aggregated data part) and sends its aggregated partition to an application server for collation into an aggregation (or reduction) of the key-value pairs from all of the workers.

Where an LBS is unable to perform the aggregation operation (e.g., due to memory or time constraint), it sends its partitions to the application server for aggregation. The application server aggregates any unaggregated partitions before collating the aggregated partitions into an aggregation of the key-value pairs from all of the workers.

In FIG. 3A, the network servers 106, 108, and 110 (referred to here as workers 1, 2, and 3) produce respectively sets 302, 304, and 306 of key-value pairs. Programmable switches 116, 118, 120, and 122 (referred to here as LBS1, LBS2, LBS3, and LBS4) have been allocated for aggregation of the key-value pairs, so the workers 1, 2, and 3 partition their respective sets of key-vale pairs into four partitions. The workers 1, 2, and 3 all use a partition function that assigns key index values w and u to the first partition, values d, s, and n to the second partition, values f and v to the third partition, and values i, e, and j to the fourth partition. Each worker sends its first through fourth partitions to LBS1 through LBS4, respectively.

LBS1 receives a group 308 of three partitions, LBS2 receives a group 310 of two partitions, LBS3 receives a group 312 of three partitions, and LBS4 receives a group 314 of one partition. LBSs 1, 2, 3, and 4 generate respectively aggregated partitions 316, 318, 320, and 322 (each is a set of key-value pairs), which they send to network server 114 (configured in this embodiment as an application server) for assembly into an aggregated set 324 of the key-value pairs from all of the workers. The aggregated key-value pairs of the aggregated set 324 are arranged in an arbitrary key index value order, but the network server 114 may arrange them in any other order in other embodiments. In this embodiment, the sets 302, 304, and 306 of key-value pairs, the partition groups 308, 310, 312, and 314, the aggregated partitions 316, 318, 320, and 322, and the aggregated set 324 of the key-value pairs may be referred to respectively as data to be aggregated, data parts, aggregated data parts, and aggregated data.

FIG. 3B illustrates a data flow 330 in which workers generate one or more sets of key-value pairs, each set associated with a job identifier. Each job identifier is further associated with an LBS that is allotted for aggregating the key-value pairs for that job. Each worker partitions each of its one or more sets of key-value pairs as individual single data parts and sends each data part to the LBS associated with the set's job identifier. The aggregated data parts are sent to an application server for its use.

In FIG. 3B, the network servers 106, 108, and 110 (referred to here as workers 1, 2, and 3) produce sets 332, 334, 336, and 338 of key-value pairs. The worker 1 is working on Job 001 and it produces set 332, which is associated with Job 001. The worker 2 is working on Job 001 and Job 002 and it produces set 334, associated with Job 001, and set 336, associated with Job 002. The worker 3 is working on Job 002 and it produces set 338, which is associated with Job 002.

The LBS1 is allocated to Job 001 and the LBS2 is allocated to Job 002. The worker 1 sends its set 332 to the LBS1. The worker 2 sends its set 334 to the LBS1 and its set 336 to the LBS2. The worker 3 sends its set 338 to the LBS2. The LBS1 aggregates the Job 001 sets 332 and 334 to generate an aggregated set (aggregated data part) 340 of key-value pairs, associated with Job 001. The LBS2 aggregates the Job 002 sets 336 and 336 to generate an aggregated set 342 of key-value pairs, associated with Job 002. The LBSs 1 and 2 send the aggregated sets 340 and 342, respectively, to the network server 114 (configured in this embodiment as an application server) which assembles the aggregated sets into aggregated data 344, which is an aggregated set of sets. In this embodiment, the sets 332, 334, 336, and 338 of key-value pairs, and the aggregated sets 340 and 342 may be referred to respectively as data to be aggregated and aggregated data parts. The workers 1, 2, and 3 may be said to have partitioned their sets 332, 334, 336, and 338 into single data parts, each of which includes all of its respective set of key-value pairs.

In the above data flows, workers generate a packet for each of their data parts. In each packet's routing header, the corresponding LBS is set as an intermediate waypoint and a network server configured as a parameter server or application server is set as the destination address. In various embodiments, the routing header may be one of an Internet Engineering Task Force (IETF) Segment Routing header and an IETF Service Function Chaining header.

Each LBS, upon receiving data parts in packets targeting the LBS as an intermediate waypoint, performs their aggregation operation on the received data parts, generating an aggregated data part that is sent to the parameter or application server. The parameter or application server concatenates or aggregates the aggregated data parts to form the aggregated data. Where the network server is configured as a parameter server, it may send the aggregated value vector to the workers for production of subsequent value vectors.

In some embodiments, INA activity may be distributed further across the data center network by assigning a plurality of LBSs to partially aggregate one or more data parts, in the place of an individual LBS, as discussed above. In some such embodiments, this is done by identifying two or more LBSs as intermediate waypoints in the routing header of a data part packet.

Either the worker or the first identified LBS partitions the data part into first and second data subparts. The first identified LBS, aggregates the first data subpart to generate a first aggregated data subpart, then sends the first aggregated data subpart and the second data subpart in a second packet to the second identified LBS. The second identified LBS aggregates the second data subpart to generate a second aggregated data subpart. In some such embodiments the second identified LBS aggregates the first and second aggregated data subparts to generate the aggregated data part and sends the aggregated data part to the parameter or application server. In other such embodiments the second identified LBS sends the first and second aggregated data subparts to the parameter or application server.

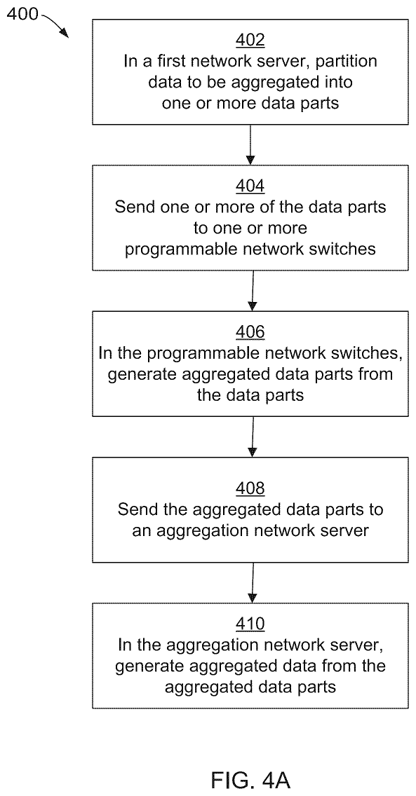

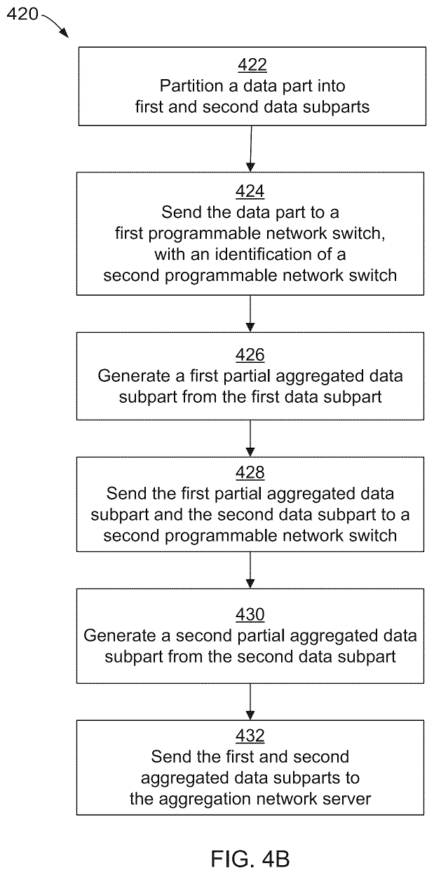

FIGS. 4A-4B illustrate methods for load balancing in an INA application according to embodiments of the disclosure. The steps of the methods are performed in network servers and programmable network switches. The methods may be applied to INC reduction of gradient vectors from a plurality of workers or to INC aggregation of key-value pairs from a plurality of workers.

FIG. 4A illustrates a method 400 for performance in a network server that is configured as a worker generating data for aggregation (e.g., one or more gradient vectors for reduction or one or more key-value pairs for aggregation). An embodiment of the steps of method 400 is described below with reference to elements of the data center network described above with reference to FIG. 1.

In step 402, the network server 106 partitions the data to be aggregated into one or more data parts. In various embodiments, the data to be aggregated may be the value vectors 202, 204, and 206, the groups of value vectors 240, 242, and 244, the sets 302, 304, and 306 of key-value pairs, or the sets 332, 334, 336, and 338 of key-value pairs. In various embodiments, the data parts may be the vector sections as discussed with reference to FIG. 2A, the full vectors 202, 204, and 206 as discussed with reference to FIG. 2B, the groups of value vectors for a single sequence number as discussed with reference to FIG. 2C, the partition groups 308, 310, 312, and 314, or the sets 332, 334, 336, and 338 of key-value pairs as discussed with reference to FIG. 3B. In step 404, the network server 106 selects one or more of the programmable network switches 116, 118, 120, and 122 and sends the data parts to the selected switch(es). The switch(es) may be selected based on a sequence number or other information associated with the data parts, or based on a number of programmable network switches allocated to INA.

In step 406, the programmable network switch (e.g., 116) generates one or more aggregated data parts from the data part(s) received from the network server 106. In various embodiments, the aggregated data parts may be the aggregated vector sections 216, 218, 220, and 222, the partial aggregated value vector 230, the aggregated value vectors 254, 256, 258, and 260, the aggregated partitions 316, 318, 320, and 322, or the aggregated sets 340 and 342. In step 408, the programmable network switch 116 sends the one or more aggregated data parts to the network server 114, which is configured in various embodiments as a parameter server or application server (an aggregation network server). In step 410, the network server 114 generates aggregated data from the one or more aggregated data parts. In various embodiments, the aggregated data may be the aggregated value vector 224, the aggregated value vector 224, the group 262 of aggregated value vectors, the aggregation 324 of the key-value pairs, or the aggregated data 344.

In some embodiments, the network server 106 sends the data parts to the programmable network switches in corresponding packets that cause the programmable network switches to perform steps 406 and 408. In some such embodiments, the packets are further configured to cause the programmable network switch 116 to send the aggregated data part(s) to the network server 114 in one or more second packets that are configured to cause the network server 114 to perform the step 410.

FIG. 4B illustrates a method 420 for performance in a network server that is configured as a worker generating a data part for aggregation and sending the data part to two programmable switches in series for partial aggregation before being sent to a parameter server or application server for final aggregation or use. An embodiment of the steps of method 420 is described below with reference to elements of the data center network described above with reference to FIG. 1. The network server 106 generates data to be aggregated, the programmable network switches 116 and 118 perform partial aggregation of a part of the data, and the network server 114 is configured to operate as a parameter server or an application server (an aggregation server).

In step 422, the data part is partitioned into first and second data subparts. In various embodiments, this partitioning may be performed in either the network server 106 (the worker) or in the programmable network switch 116 (a first programmable network switch). In step 424, the network server 106 selects one or more of the programmable network switches 116, 118, 120, and 122 (in this example, the switches 116 and 118) and sends the data part (or the first and second data subparts) to the programmable network switch 116 along with an identification of the programmable network switch 118 (a second programmable network switch). If the full data part is sent to the programmable network switch 116, it performs step 422 and partitions the data part into the first and second data subparts. The switches may be selected based on a sequence number or other information associated with the data part, or based on a number of programmable network switches allocated to INA.

In step 426, the programmable network switch 116 generates a first partial aggregated subpart from the first data subpart. In step 428, the programmable network switch 116 sends the first partial aggregated subpart and the second data subpart to the programmable network switch 118 (a second programmable network switch). In step 430, the programmable network switch 118 generates a second partial aggregated subpart from the second data subpart. In some embodiments, the programmable network switch 118 further aggregates the first and second partial aggregated subparts to generate an aggregated data part. In step 432, the programmable network switch 118 sends the first and second partial aggregated subparts or the aggregated data part to the network server 114 (an aggregation server) for final aggregation or use.

In some embodiments, the network server 106 sends the data part (or the first and second data subparts) in a packet whose routing header includes a network address of the programmable network switch 116 as a first intermediate waypoint, a network address of the programmable network switch 118 as a second intermediate waypoint, and a network address of the network server 114 as the destination address of the packet. In some such embodiments, the routing header may be an Internet Engineering Task Force (IETF) Segment Routing header or an IETF Service Function Chaining header.

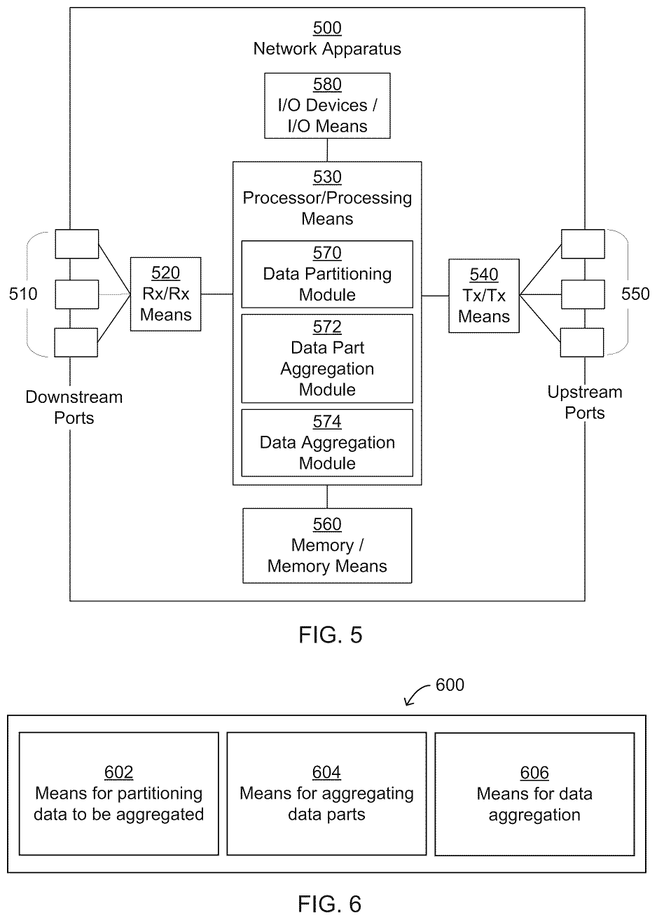

FIG. 5 is a diagram of a network apparatus 500 (e.g., a network server or a programmable network switch, etc.) according to an embodiment of the disclosure. The network apparatus 500 is suitable for implementing the disclosed embodiments as described herein. The network apparatus 500 comprises ingress ports/ingress means 510 coupled to receiver units (Rx)/receiving means 520 for receiving data; a processor, logic unit, or central processing unit (CPU)/processing means 530 (coupled to the Rx/receiving means 520) to process the data; transmitter units (Tx)/transmitting means 540 and egress ports/egress means 550 (coupled to the processor/processing means 530) for transmitting the data; and a memory/memory means 560 (coupled to the processor/processing means 530) for storing the data. The network apparatus 500 may also comprise optical-to-electrical (OE) components and electrical-to-optical (EO) components coupled to the ingress ports/ingress means 510, the receiver units/receiving means 520, the transmitter units/transmitting means 540, and the egress ports/egress means 550 for egress or ingress of optical or electrical signals.

The processor/processing means 530 is implemented by hardware and software. The processor/processing means 530 may be implemented as one or more processor components such as CPU chips, cores (e.g., as a multi-core processor), field-programmable gate arrays (FPGAs), application specific integrated circuits (ASICs), or digital signal processors (DSPs). The processor/processing means 530 is in communication with the ingress ports/ingress means 510, receiver units/receiving means 520, transmitter units/transmitting means 540, egress ports/egress means 550, and memory/memory means 560. The processor/processing means 530 comprise one or more of a data partitioning module 570, a data part aggregation module 572, and a data aggregation module 574. In various embodiments, one or more of the modules 570, 572, and 574 are stored in onboard memory of the processor/processing means 530. The data partitioning module 570 is able to implement steps 402 and 404 of the method 400 and steps 422 and 424 of the method 420 as described respectively with reference to FIGS. 4A-4B. The data part aggregation module 572 is able to implement steps 406 and 408 of the method 400 and steps 426 and 428 or steps 430 and 432 of the method 420 as described respectively with reference to FIGS. 4A-4B. The data aggregation module 574 is able to implement step 410 of the method 400 as described with reference to FIG. 4A.

The inclusion of the data partitioning module 570, the data part aggregation module 572, and the data aggregation module 574 therefore provide a substantial improvement to the functionality of the network apparatus 500 and effects a transformation of the network apparatus 500 to a different state. Alternatively, the data partitioning module 570, the data part aggregation module 572, and/or the data aggregation module 574 are implemented as computer executable instructions stored in the memory/memory means 560 and executed by the processor/processing means 530.

The network apparatus 500 may also include input and/or output (I/O) devices/I/O means 580 for communicating data to and from a user. The I/O devices or means 580 may be coupled to the processor/processing means 530. The I/O devices I/O means 580 may include output devices such as a display for displaying video data, speakers for outputting audio data, etc. The I/O devices or means 580 may also include input devices, such as a keyboard, mouse, trackball, etc., and/or corresponding interfaces for interacting with such output devices.

The memory/memory means 560 comprises one or more memory components such as disks, tape drives, or solid-state drives and may be used as an over-flow data storage device, may be used to store programs when such programs are selected for execution, to store computer executable instructions that are read during program execution and to store data for execution or generated during execution. The memory/memory means 560 may be volatile and/or non-volatile and may be read-only memory (ROM), random access memory (RAM), ternary content-addressable memory (TCAM), and/or static random-access memory (SRAM).

FIG. 6 illustrates a network apparatus 600 configured to implement one or more of the methods for INA as described herein. For example, the network apparatus 600 is configured to implement the methods described with reference to FIGS. 4A-4B. The network apparatus 600 may be implemented in the network device 500. The network apparatus 600 comprises a means 602 for partitioning data to be aggregated according to steps 402 and 404 of the method 400 and steps 422 and 424 of the method 420 as described respectively with reference to FIGS. 4A-4B. The network apparatus 600 may further comprise a means 604 for aggregating data parts according to steps 406 and 408 of the method 400 and steps 426 and 428 or steps 430 and 432 of the method 420 as described respectively with reference to FIGS. 4A-4B. The network apparatus 600 may still further comprise a means 606 for aggregating data according to step 410 of the method 400 as described with reference to FIG. 4A.

The data aggregation module 574 is able to implement step 410 of the method 400 as described with reference to FIG. 4A.

The disclosed embodiments may be a system, an apparatus, a method, and/or a computer program product at any possible technical detail level of integration. The computer program product may include a computer readable storage medium (or media) having computer readable program instructions thereon for causing a processor to carry out aspects of the present disclosure. The computer readable storage medium may be a tangible device that can retain and store instructions for use by an instruction execution device. While several embodiments have been provided in the present disclosure, it may be understood that the disclosed systems and methods might be embodied in many other specific forms without departing from the spirit or scope of the present disclosure. The present examples are to be considered as illustrative and not restrictive, and the disclosure is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method of load balancing in an In-Network Aggregation (INA) application, implemented by a network server, the method comprising:
partitioning data to be aggregated one or more value vectors into one or more data parts;
determining a corresponding programmable network switch for each of the data parts; and
sending each of the data parts in a packet comprising a routing header including (i) an intermediate waypoint comprising a network address of the corresponding programmable network switch and (ii) a destination address comprising a network address of an aggregation network server.

2. The method of claim 1, wherein the data to be aggregated comprises one of (i) one or more value vectors and (ii) one or more sets of key-value pairs.

3. The method of claim 1, wherein:
each data part is associated with a sequence number, the method further comprising; and
the corresponding programmable network switch for each data part is determined based on the sequence number associated with the data part.

4. The method of claim 1, wherein:
N programmable network switches are allocated for INA; and
the corresponding programmable network switch for each data part is determined based further on a value of N.

5. The method of claim 1, wherein:
the data to be aggregated comprises one or more sets of key-value pairs;
each key-value pair of the one or more sets of key-value pairs comprises a key index value; and
the one or more sets of key-value pairs are partitioned into the one or more data parts based upon the key index value of each key-value pair.

6. The method of claim 1, wherein:
the data to be aggregated comprises one or more sets of key-value pairs;
each set of the one or more sets of key-value pairs is associated with a job identifier;
the one or more sets of key-value pairs are partitioned into the one or more data parts based upon the job identifier associated with each set of key-index pairs; and
the corresponding programmable network switch for each data part is determined based on the job identifier associated with each set of key-index pairs.

7. The method of claim 1, wherein the intermediate waypoint is a first intermediate waypoint and each routing header further comprises a second intermediate waypoint comprising a network address of a second programmable network switch.

8. The method of claim 1, further comprising:
partitioning each data part into corresponding first and second data subparts,
wherein sending each data part comprises sending the corresponding first and second data subparts.

9. The method of claim 1, wherein the routing header is one of an Internet Engineering Task Force (IETF) Segment Routing header and an IETF Service Function Chaining header.

10. A method of load balancing in an In-Network Aggregation (INA) application, implemented by a programmable network switch, the method comprising:
receiving a plurality of first packets, each first packet comprising a first data part, the first data part comprising one of a value vector and a set of key-value pairs, each first packet comprising a first routing header including (i) an intermediate waypoint comprising a network address of the programmable network switch and (ii) a destination address comprising a network address of an aggregation network server;
aggregating the first data parts to generate an aggregated data part; and
sending the aggregated data part in a second packet, the second packet comprising a second routing header including a destination address comprising the network address of the aggregation network server.

11. The method of claim 10, wherein:
each first data part comprises a value vector and each value vector is associated with a FIRST sequence number;
a first set of value vectors are associated with a first sequence number and a second set of value vectors are associated with a second sequence number;
generating an aggregated data part comprises:
aggregating the first set of data parts to generate a first aggregated data part and associating the first aggregated data part with the first sequence number; and
aggregating the second set of data parts to generate a second aggregated data part and associating the second aggregated data part with the second sequence number; and
sending the aggregated data part in the second packet comprises sending:
the first aggregated data part and the associated first sequence number; and
the second aggregated data part and the associated second sequence number.

12. The method of claim 10, wherein:
each first data part comprises a set of key-value pairs and each set of key-value pairs is associated with a first job number;
a first set of first data parts comprises sets of key-value pairs associated with a first job number and a second set of first data parts comprises sets of key-value pairs associated with a second job number;
aggregating the first data parts to generate an aggregated data part comprises:
aggregating the first set of data parts to generate a first aggregated data part and associating the first aggregated data part with the first job number; and
aggregating the second set of data parts to generate a second aggregated data part and associating the second aggregated data part with the second job number; and
sending the aggregated data part in the second packet comprises sending:
the first aggregated data part and the associated first job number; and
the second aggregated data part and the associated second job number.

13. The method of claim 10, wherein:
the intermediate waypoint is a first intermediate waypoint;
each first routing header further comprises a second intermediate waypoint comprising a network address of a second programmable network switch; and
each first data part comprises a first data subpart and a second data subpart,
the method further comprises:
aggregating each of the first data subparts to generate a first aggregated data subpart; and
sending the first aggregated data subpart and the second data subpart in a third packet comprising a third routing header including (i) an intermediate waypoint comprising the network address of the second programmable network switch and (ii) a destination address comprising the network address of the aggregation network server.

14. The method of claim 10, further comprising:
receiving a plurality of fourth packets, each fourth packet comprising a first aggregated data subpart and a second data subpart;
aggregating the second data subpart to generate a second aggregated data subpart; and
aggregating the first aggregated data subpart and the second aggregated data subpart to generate the aggregated data part.

15. The method of claim 10, further comprising:
receiving a plurality of fifth packets, each fifth packet comprising a first aggregated data subpart and a second data subpart;
aggregating the second data subpart to generate a second aggregated data subpart; and
sending the first aggregated data subpart and the second aggregated data subpart in a sixth packet, the sixth packet comprising a third routing header including a destination address comprising the network address of the aggregation network server.

16. The method of claim 10, further comprising:
determining, by the programmable network switch, that it cannot generate an aggregated data part and, in response, sending the first data parts to the aggregation network server.

17. A method of load balancing in an In-Network Aggregation (INA) application, implemented by a network server configured as an aggregation server, the method comprising:
receiving a plurality of first packets from a corresponding plurality of programmable network switches, each first packet comprising an aggregated data part, the aggregated data part comprising one of a sub-vector of a value vector and a set of key-value pairs; and
generating aggregated data from the aggregated data parts, wherein:
where the aggregated data part comprises a sub-vector of a value vector, the aggregated data is generated by concatenating the aggregated data parts; and
where the aggregated data part comprises a set of key-value pairs, the aggregated data is generated by assembling the aggregated data parts into an aggregated set of key-value pairs.

18. The method of claim 17, wherein:
each aggregated data part comprises a value vector and associated sequence number; and
generating the aggregated data comprises assembling the aggregated data parts into a group of value vectors with associated sequence numbers.

19. The method of claim 17, wherein the network server is configured as a parameter server.

20. The method of claim 17, further comprising sending the aggregated data to one or more other network servers.
